(19) United States
(12) Patent Application Publication
(10) Pub. No.: US 2015/0287341 A1
(43) Pub. Date: Oct. 8, 2015

(54) METHOD FOR EFFECTIVE TEACHING USING A GAME

(71) Applicants: Lettie Weiner, Mesa, AZ (US); Neil Weiner, Mesa, AZ (US)

(72) Inventors: Lettie Weiner, Mesa, AZ (US); Neil Weiner, Mesa, AZ (US)

(21) Appl. No.: 14/244,738

(22) Filed: Apr. 3, 2014

(51) Int. Cl. G09B 19/22

(52) U.S. Cl. CPC G09B 19/22

(57) ABSTRACT

This game solves the problem of effectively enhancing the learning experience by providing a teaching problem on one card while the answer is on another card. The person who has the card with the correct answer can play that card. Obviously, the student must be aware that the card has the correct answer or the card will not get played. The object of the game is to run out of cards last. Thus, it is to the player's advantage to recognize cards within his or her hand that contain a correct answer. When a correct answer is played, that card then forms the next question to be answered and all players must examine their hands in order to determine if they possess a correct answer that can be played.

### CROSS REFERENCE TO RELATED APPLICATION[S]

This application is a claims priority to U.S. Provisional Patent Application entitled “Business Method for Effective Teaching Using a Game,” Ser. No. 67/853,437, filed Apr. 5, 2013, now pending, the disclosure of which is hereby incorporated entirely herein by reference.

### BACKGROUND OF THE INVENTION

This invention falls within the fields of teaching tools and games. Various game types have been used as teaching tools including role playing games, computer simulations, board games, and finally card games. This invention falls most particularly within the field of a teaching tool taking the form of a card game.

### BRIEF SUMMARY OF THE INVENTION

In summary, a product that can improve the learning experience is in high demand as student performance continues to lag behind expectations. This game solves the problem of effectively enhancing the learning experience by providing a teaching problem on one card while the answer is on another card. The person who has the card with the correct answer can play that card. Obviously, the student must be aware that the card has the correct answer or the card will not get played. The object of the game is to run out of cards. Thus, it is to the player's advantage to recognize cards within his or her hand that contain a correct answer. Each card bears a question and an answer, but the answer to the question is on another card. When a correct answer is played, that card then forms the next question to be answered and all players must examine their hands in order to determine if they possess a correct answer that can be played.

The foregoing and other features and advantages of the present invention will be apparent from the following more detailed description of the particular embodiments of the invention, as illustrated in the accompanying drawings.

### BRIEF DESCRIPTION OF THE SEVERAL VIEWS OF THE DRAWINGS

FIG. 1 shows a card in a multiplication teaching embodiment of the invention.

FIG. 2 shows a card in a multiplication teaching embodiment of the invention.

FIG. 3 shows a card in a chemistry teaching embodiment of the invention.

FIG. 4 shows a card in a chemistry teaching embodiment of the invention.

FIG. 5 shows a card in a geography teaching embodiment of the invention.

FIG. 6 shows a card in a geography teaching embodiment of the invention.

FIG. 7 shows a card answering FIG. 8 in a general case of the invention.

FIG. 8 shows a card asking for FIG. 7 in a general case of the invention.

### DETAILED DESCRIPTION OF THE INVENTION

This game solves the problem of effectively enhancing the learning experience by providing a teaching problem on one card while the answer is on another card. The person who has the card with the correct answer can play that card. Obviously, the student must be aware that the card has the correct answer or the card will not get played. The object of the game is to run out of cards last. Thus, it is to the player's advantage to recognize cards within his or her hand that contain a correct answer. When a correct answer is played, that card then forms the next question to be answered and all players must examine their hands in order to determine if they possess a correct answer that can be played. The invention is a boxed game set consisting of four color coded decks of cards, with one referee card for each deck, a “Cheat Sheet” for each player, and a sheet of directions to play.

The inventors refer to this game as FLASHFACTS™ and the directions are as follows. FLASHFACTS™ is a card game designed to help players memorize certain facts. Unlike traditional flash cards FLASHFACTS™ allows several participants to practice their facts at once and have fun at the same time. It is important for players to alternate using each of the four color coded decks when playing the game. This will insure that players practice and learn the given facts without simply memorizing the order of the facts covered.

First, shuffle each deck thoroughly and deal each color coded deck individually. The number of players can vary with each game as long as each player is dealt the same number of cards. If, when each player is dealt the same number of cards, there are cards left over place the remaining cards on the playing surface face up to be played at the appropriate time during a round of play.

“Cheat Sheets” with all the possible answers for the version being played have been provided for each player to use until enough of the facts have been memorized by the players to render the play of the game smooth. When players have a good grasp of the facts covered in this version of the game the “Cheat Sheets” and referee position are no longer needed. Play of the game should move much quicker at this point.

Choose the first person to play a card using any method preferred. Each player silently chooses an answer for the question displayed on the played card. The player holding a card with the answer to that question (in the preferred embodiment found in the upper left corner of the card) plays that card next. That card shows a new question. The player holding a card with the answer to that question (in the upper left corner of the card in the preferred embodiment) plays that card. Continue playing in this way until the last card is played. The person correctly playing the last card is the winner of this round even if that person is playing alone. The last player out is the winner.

The referee card is used by one person chosen as the referee. This person does not play during this round except to follow the play to make sure the correct cards are played in the proper order. There are two possible mistakes. One is when a player plays the wrong card and the other is when a player takes too long to play the right card. To acknowledge these infractions the referee simply says, “Wrong card.” or “Too long.” The player who played the wrong card retrieves it. In both cases the referee says, “Play the right card.” If no one plays the right card the referee announces what the right card is. If it is a case of a wrong card played, the person who played the wrong card allows the player to his or her right to blindly draw a card from his or her hand. If it is a case of taking too long to play, the person who should have played the card plays it and then allows the person to his or her left to blindly draw a card from his or her hand. Play continues. If, at the end, there is only one person holding cards that person continues to play. If that person makes a mistake by playing the wrong card or by taking too long to play, these rules apply. One of the players to the right or left of the last player could be, but is not always, the winner. The winner of the round moves to the referee position or if there is no referee position the winner can start the next round.

To get the full experience use a different color coded deck to play subsequent rounds until all four decks have been played by this group of players. Shuffle each deck thoroughly before playing each round. (When one boxed game is shared among four groups of players, each group plays one round with each colored deck then passes that deck to the next group until each group has played each color coded deck at least once.)

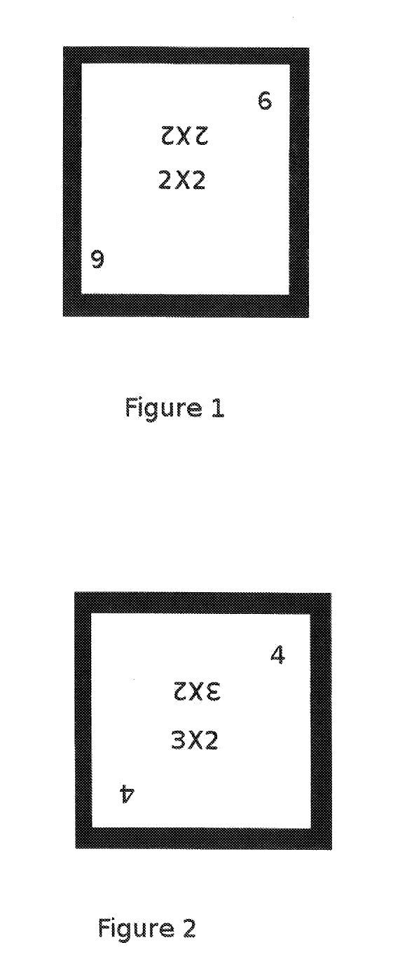

Turning now to FIGS. 1 and 2 an embodiment of the invention can be seen which may be used to teach rudimentary multiplication. In the center of the card represented by FIG. 1 is a question, specifically “What is two times two?” The answer on that card, placed here in the upper left, is the answer to the question on a different card shown by FIG. 2. The answer to the question on FIG. 1 is shown at the upper left of FIG. 2. This is a fundamental case in that there are only two cards in this deck. Optimally a deck would have many cards with many questions in the same genre. The only limitations are that every question should have a corresponding answer within the deck, and that answer should not be on the same card as the corresponding question. The question always appears in the same place on each card. The answer always appears in the same place on each card. In the preferred embodiment shown the questions are at the center of the card while the answers are at the upper left although other configurations are possible and would not depart from the ideas of this invention as long as the players can clearly identify which is the question and which is the answer on any given card.

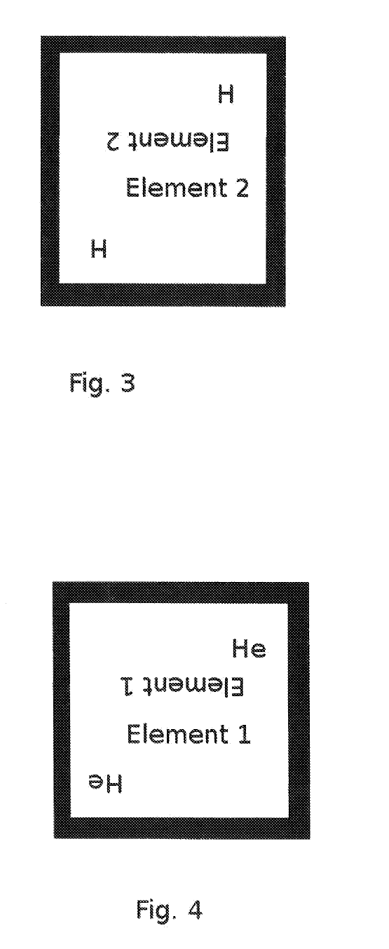

Turning now to FIGS. 3 and 4, a version of the game is shown that is designed to teach the periodic table of the elements. Only two cards are shown, but this deck would obviously comprise a question and an answer for each of the elements with the question and corresponding answer appearing on different cards.

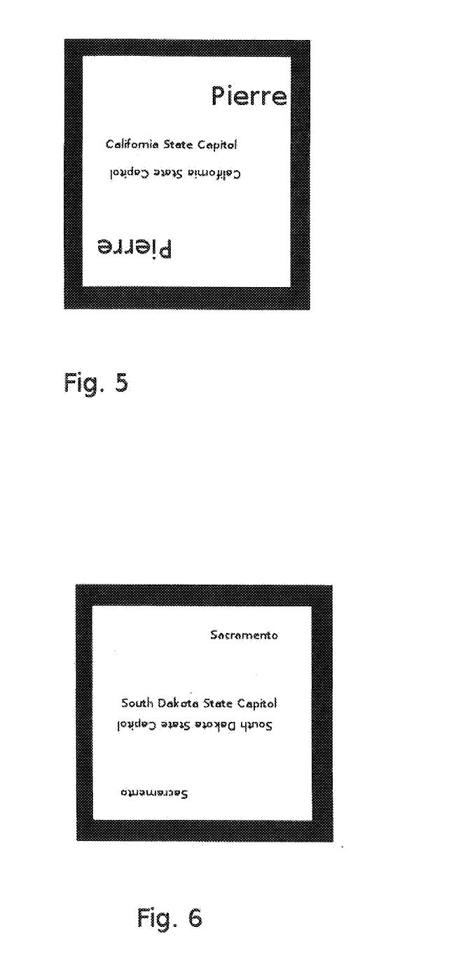

Turning now to FIGS. 5 and 6, a version of the game is shown involving state capitols of the United States. Anything susceptible to teaching involving reasoning or memorization can be made into a deck of teaching cards under this invention.

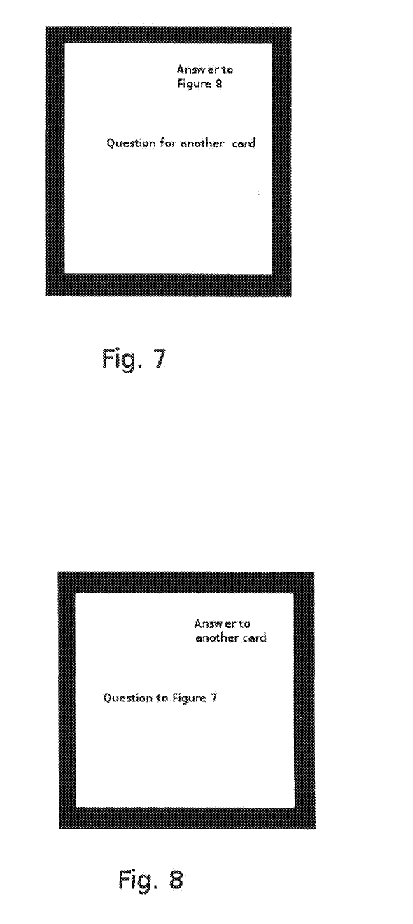

Turning now to FIGS. 7 and 8, the general case is shown where the question on one card is answered by the answer on another, and all the cards in the deck are linked by this arrangement.

### Directions to Play FLASHFACTS

FLASHFACTS™ is a card game designed to help players memorize certain facts. Unlike traditional flash cards

FLASHFACTS™ allows several participants to practice their facts at once and have fun at the same time. It is important for players to alternate using each of the four color coded decks when playing the game. This will insure that players practice and learn the given facts without simply memorizing the order of the facts covered.

FLASHFACTS™ is a boxed game consisting of four color coded decks, one referee card for each deck, “Cheat Sheet” for each player and a sheet of directions to play.

Directions:

1. Shuffle each deck thoroughly and deal each color coded deck individually.

2. Number of players can vary with each game as long as each player is dealt the same number of cards. If, when each player is dealt the same number of cards, there are cards left over place the remaining cards on the playing surface face up to be played at the appropriate time during a round of play. “Cheat Sheets” with all the possible answers for the version being played have been provided for each player to use until enough of the facts have been memorized by the players to render the play of the game smooth. When players have a good grasp of the facts covered in this version of the game the “Cheat Sheets” and referee position are no longer needed. Play of the game should move much quicker at this point.

3. Choose the first person to play a card using any method preferred.

4. Each player silently chooses an answer for the question displayed on the played card. The player holding a card with the answer to that question in the upper left corner plays that card next. That card shows a new question. The player holding a card with the answer to that question in the upper left corner plays that card. Continue playing this way until the last card is played. The person correctly playing the last card is the winner of this round even if that player is playing alone. Remember the LAST player out is the WINNER.

5. The Referee Card is used by one person chosen as the referee. This person does not play during this round except to follow the play to make sure that the correct cards are played in the proper order. There are two possible mistakes. One is when a player plays the wrong card and the other is when a player takes too long to play the right card. To acknowledge these infractions the referee simply says, “Wrong card” or “Too long”. The player who played the wrong card retrieves it. In both cases the referee says, “Play the right card”. If no one plays the right card the referee announces what the right card is. If it is a case of wrong card played the person who played the wrong card allows the player to his/her right to blindly draw a card from his/her hand. If it is a case of taking too long to play, the person who should have played the card plays it and then allows the person to his/her left to blindly draw a card from his/her hand. Play continues. If, at the end, there is only one person holding cards that person continues to play. If that person makes a mistake by playing the wrong card or by taking too long to play these rules apply. One of the players to the right or left of the last player could be, but is not always, the winner. The winner of the round moves to the referee position or if there is no referee position the winner can start the next round.

6. To get the full experience use a different color coded deck to play subsequent rounds until all four decks have been played by this group of players. Shuffle each deck thoroughly before playing each round.

(When one boxed game is shared among 4 groups of players, each group plays one round with each colored deck then passes that deck to the next group until each group has played each color coded deck at least once.)

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A method of teaching using a game comprising:
selecting a number of players;
dealing a same number of cards to each player from a deck of cards of the game, wherein
each card comprises a question and an answer, the answer corresponding to the
question of another card;
selecting a player to play a card to start game play;
silently choosing an answer for the played card; and
playing a card having an answer that corresponds to the question on the played card.

2. The method of claim 1, further comprising using a referee card, wherein the referee card is used by one of the players, wherein the player with the referee card does not play during a round that the player holds the referee card and determines if the correct card is played.

3. The method of claim 1, further comprising providing a cheat sheet, wherein the cheat sheet displays all possible answers to questions on the cards.

4. The method of claim 1, wherein the cards contain mathematics questions.

5. The method of claim 1, wherein the cards contain chemistry questions.

6. The method of claim 5, wherein the chemistry questions include elements from the periodic table.

7. The method of claim 1, wherein the questions are geography questions.

8. The method of claim 7, wherein the geography questions are state capitols.
